(19) United States
(12) Patent Application Publication
(10) Pub. No.: US 2015/0380828 A1
(43) Pub. Date: Dec. 31, 2015

(54) SLOTTED SURFACE SCATTERING ANTENNAS

(71) Applicant: Searete LLC, Bellevue, WA (US)

(72) Inventors: ERIC J. BLACK, BOTHELL, WA (US); BRIAN MARK DEUTSCH, SNOQUALMIE, WA (US); ALEXANDER REMLEY KATKO, BELLEVUE, WA (US); MELROY MACHADO, BELLEVUE, WA (US); JAY HOWARD MCCANDLESS, ALPINE, CA (US); YAROSLAV A. URZHUMOV, BELLEVUE, WA (US)

(21) Appl. No.: 14/755,579

(22) Filed: Jun. 30, 2015

Related U.S. Application Data
(63) Continuation-in-part of application No. 14/506,432, filed on Oct. 3, 2014.
(60) Provisional application No. 61/988,023, filed on May 2, 2014.

(51) Int. Cl. H01Q 13/28; H01Q 23/00; H01Q 13/22; H01P 3/08; H01H 59/00

(52) U.S. Cl. CPC H01Q 13/28; H01P 3/08; H01H 59/0009; H01Q 13/22; H01Q 23/00

(57) ABSTRACT

Surface scattering antennas with lumped elements provide adjustable radiation fields by adjustably coupling scattering elements along a waveguide. In some approaches, the scattering elements include slots in an upper surface of the waveguide, and the lumped elements are configured to span the slots provide adjustable loading. In some approaches, the scattering elements are adjusted by adjusting bias voltages for the lumped elements. In some approaches, the lumped elements include diodes or transistors.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)).

### PRIORITY APPLICATIONS

The present application constitutes a continuation-in-part of U.S. patent application Ser. No. 14/506,432, entitled SURFACE SCATTERING ANTENNAS WITH LUMPED ELEMENTS, naming Pai-Yen Chen, Tom Driscoll, Siamak Ebadi, John Desmond Hunt, Nathan Ingle Landy, Melroy Machado, Jay McCandless, Milton Perque, Jr., David R. Smith, and Yaroslav A. Urzhumov as inventors, filed 3, Oct. 2014 with attorney docket no. 0209-011-003-000000, which is currently co-pending or is an application of which a currently co-pending application is entitled to the benefit of the filing date, and which is a non-provisional of U.S. Patent Application No. 61/988,023, entitled SCATTERING ANTENNAS WITH LUMPED ELEMENTS, naming Pai-Yen Chen, Tom Driscoll, Siamak Ebadi, John Desmond Hunt, Nathan Ingle Landy, Melroy Machado, Milton Perque, Jr., David R. Smith, and Yaroslav A. Urzhumov as inventors, filed 2, May, 2014 with attorney docket no. 0209-011-003-PR0001.

If the listings of applications provided above are inconsistent with the listings provided via an ADS, it is the intent of the Applicant to claim priority to each application that appears in the Domestic Benefit/National Stage Information section of the ADS and to each application that appears in the Priority Applications section of this application.

All subject matter of the Priority Applications and of any and all applications related to the Priority Applications by priority claims (directly or indirectly), including any priority claims made and subject matter incorporated by reference therein as of the filing date of the instant application, is incorporated herein by reference to the extent such subject matter is not inconsistent herewith.

All subject matter of the above applications is incorporated herein by reference to the extent such subject matter is not inconsistent herewith.

### BRIEF DESCRIPTION OF THE FIGURES

FIGS. 1A-1B depict schematic configurations of scattering elements.

FIGS. 2A-2B depict exemplary physical layouts corresponding to the schematic configurations of FIGS. 1A-1B.

FIGS. 3A-3B depict a first illustrative embodiment of a surface scattering antenna.

FIG. 4 depicts a second illustrative embodiment of a surface scattering antenna.

FIG. 5 depicts a third illustrative embodiment of a surface scattering antenna.

FIGS. 6A-6B depict a fourth illustrative embodiment of a surface scattering antenna.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The embodiments relate to surface scattering antennas. Surface scattering antennas are described, for example, in U.S. Patent Application Publication No. 2012/0194399 (hereinafter “Bily I”), with improved surface scattering antennas being further described in U.S. Patent Application Publication No. 2014/0266946 (hereinafter “Bily II”). Surface scattering antennas that include a waveguide coupled to adjustable scattering elements loaded with lumped devices are described in U.S. application Ser. No. 14/506,432 (hereinafter “Chen I”), while various holographic modulation pattern approaches are described in U.S. patent application Ser. No. 14/549,928 (“hereinafter Chen II”). All of these patent applications are herein incorporated by reference in their entirety.

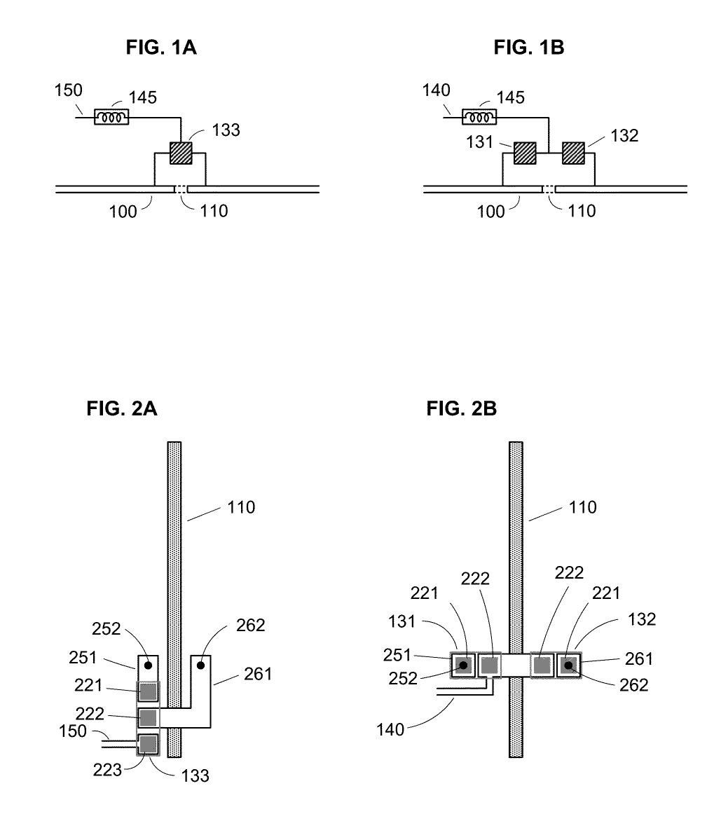

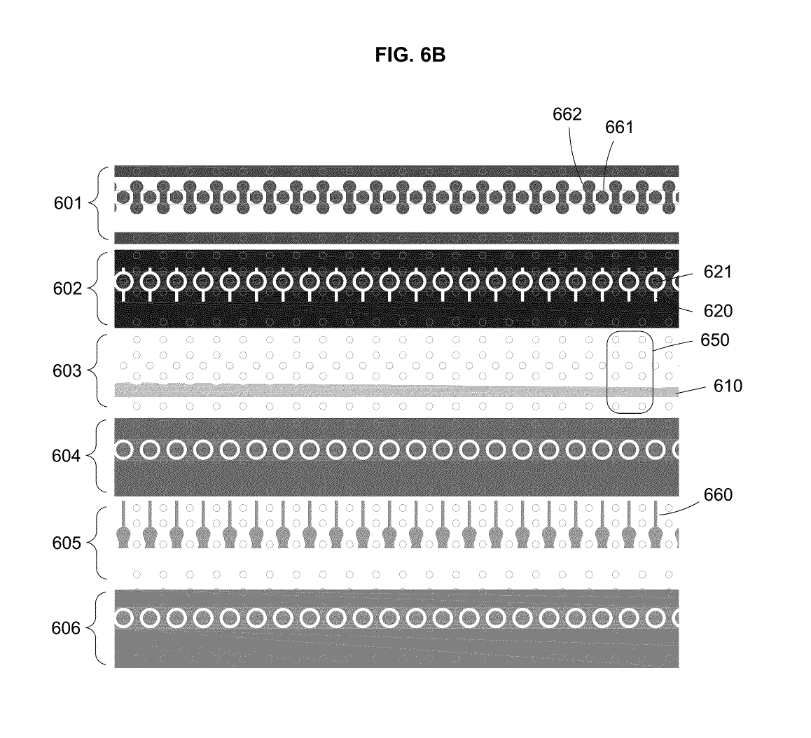

Turning now to a consideration of the scattering elements that are coupled to the waveguide, FIGS. 1A and 1B depict schematic configurations of scattering elements that are defined by a slot or aperture 110 in the ground body 100. For example, the scattering element may be a slot 110 on the upper conductor of a waveguide such as a substrate-integrated waveguide or stripline waveguide. As another example, the scattering element may be a CSRR (complementary split ring resonator) defined by an aperture 110 on the upper conductor of such a waveguide. The scattering element of FIG. 1A is made adjustable by connecting a three-port lumped element 133 across the aperture 110 to control the impedance across the aperture, with a bias control line 150 connected to a third port of the three-port element (with optional bias isolation, as illustrated by the RF choke 145). The scattering element of FIG. 1B is made adjustable by connecting two-port lumped elements 131 and 132 in series across the aperture 110, with a bias control line 140 providing a bias between the two-port lumped elements and the ground body (with optional bias isolation, as illustrated by the RF choke 145). Both lumped elements could be tunable nonlinear lumped elements, such as PIN diodes or varactors, or one could be a passive lumped element, such as a blocking capacitor. The bias control line isolation approaches contemplated in the context of Chen I FIGS. 6A-6D are again contemplated here, as are embodiments that include further lumped elements connected in series or in parallel (for example, a single slot could be spanned by multiple lumped elements placed at multiple positions along the length of the slot).

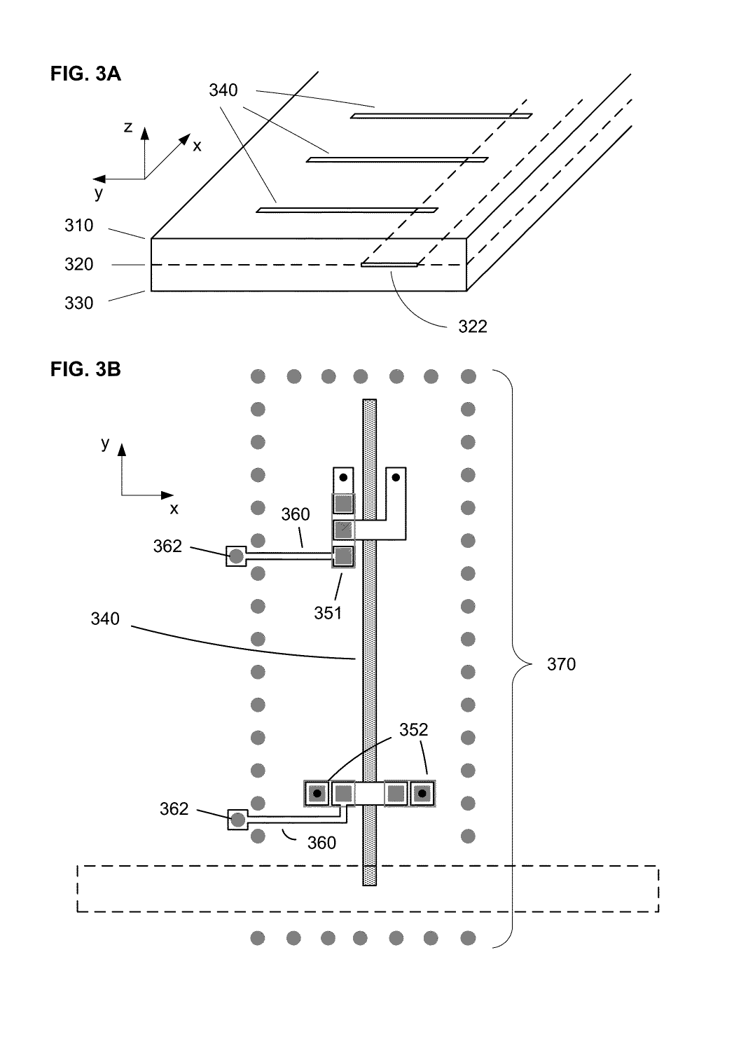

FIGS. 2A and 2B depict exemplary physical layouts corresponding to the schematic lumped element arrangements of FIGS. 1A and 1B, respectively. The figures depict top views of an individual unit cell or scattering element, and the numbered figure elements depicted in FIGS. 1A and 1B are numbered in the same way when they appear in FIGS. 2A and 2B.

With reference to FIG. 2A, the figure depicts an exemplary physical layout corresponding to the schematic three-port lumped element arrangement of FIG. 1A. Vias 252 and 262, situated on either side of the slot 110, connect metal regions 251 and 261 (on an upper metal layer) with the ground body 100 (on a lower metal layer). Then the three-port lumped element 133 is implemented as a surface-mounted component with a first contact 221 that connects the lumped element to the first metal region 251, a second contact 222 that connects the lumped element to the second metal region 261, and a third contact 223 that connects the lumped element to the bias control line 150 (on the upper metal layer).

With reference to FIG. 2B, the figure depicts an exemplary physical layout corresponding to the schematic two-port lumped element arrangement of FIG. 1B. Vias 252 and 262, situated on either side of the slot 110, connect metal regions 251 and 261 (on an upper metal layer) with the ground body 100 (on a lower metal layer). Then the first two-port lumped element 131 is implemented as a surface-mounted component with a first contact 221 that connects the lumped element to the first metal region 251 and a second contact 222 that connects the lumped element to the bias control line 140 (on the upper metal layer); and the second two-port lumped element 132 is implemented as a surface-mounted component with a first contact 221 that connects the lumped element to the second metal region 261 and a second contact 222 that connects the lumped element to the bias control line 140.

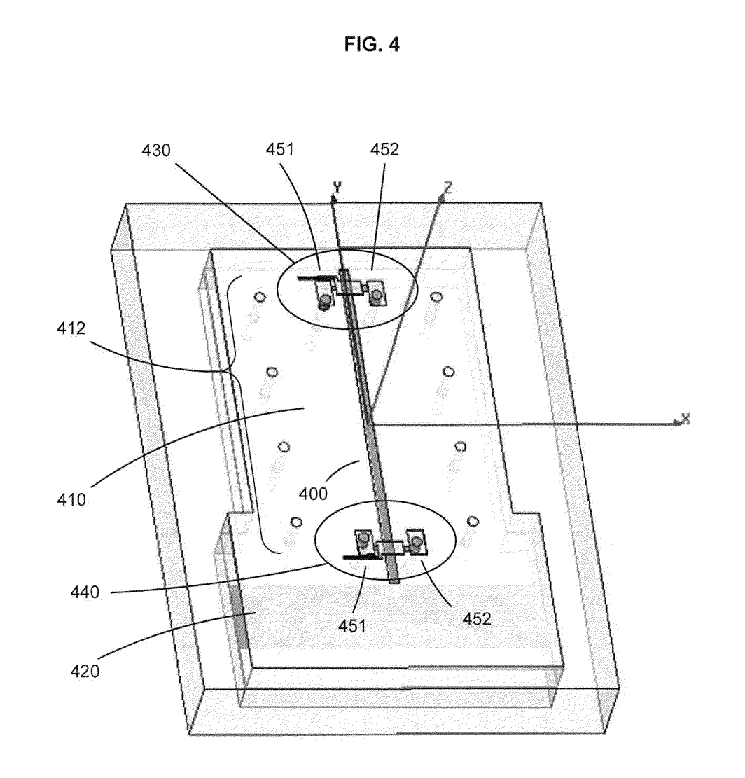

With reference now to FIGS. 3A-3B, a first illustrative embodiment of a surface scattering antenna is depicted. In this embodiment, the waveguide is a stripline structure having an upper conductor 310, a middle conductor layer 320 providing the stripline 322, and a lower conductor layer 330. The scattering elements are a series of slots 340 in the upper conductor, and the impedances of these slots are controlled with lumped elements arranged as in FIGS. 1A, 1B, 2A, and 2B. An exemplary top view of a unit cell is depicted in FIG. 3B. In this example, lumped elements 351 and 352 are arranged to span the upper and lower ends of the slot, respectively, with bias control lines 360 on the top layer of the assembly connected by through vias 362 to bias control circuitry on the bottom layer of the assembly (not shown). In this example, the upper lumped element 351 is a three-port lumped element as in FIG. 2A, while the lower lumped elements 352 are two-port lumped elements as in FIG. 2B. Each unit cell optionally includes a via cage 370 to define a cavity-backed slot structure fed by the stripline as it passes through successive unit cells.

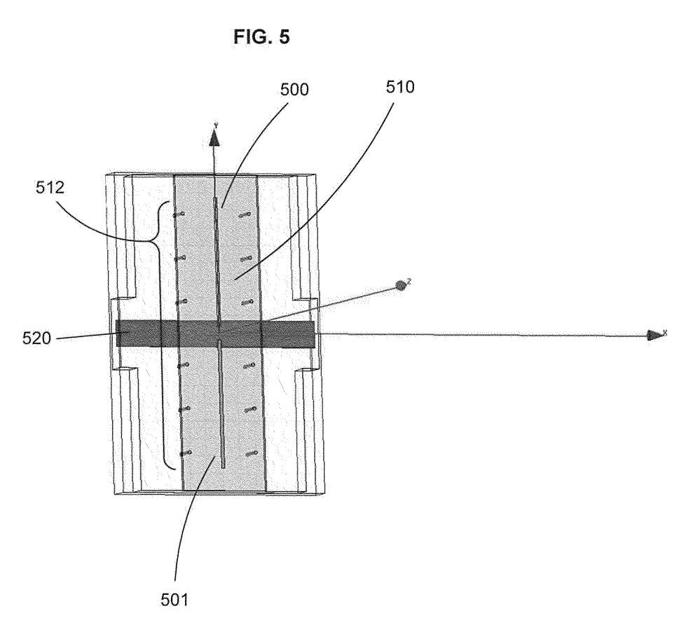

With reference now to FIG. 4, a second illustrative embodiment of a surface scattering antenna is depicted. The figure depicts a unit cell of the antenna, including a slot 400 backed by a cavity 410 defined by an optional via cage 412 and fed by the stripline 420 as it proceeds through successive unit cells. The slot includes lumped element loading at an upper station 430 closer to an upper end of the slot 400 and lumped element loading at a lower station 440 closer to a lower end of the slot 400. This illustration is not intended to be limiting; other embodiments provide loading at only a single station along the slot, or loading at more than two stations along the slot. In this example, each station includes a pair of two-port lumped elements 451, 452 connected in series across the slot, but again, this is not intended to be limiting, and some or all stations could use three-port elements.

In some approaches, the pair of two-port lumped elements 451, 452 is a pair of nonlinear variable-impedance devices. For example, the pair of two-port elements can be a pair of varactors (such as solid state or MEMS varactors) or switched capacitors (such as MEMS switched capacitors). In approaches that use a pair of diodes such as varactors diodes, the pair of diodes might be arranged so that each diode has a cathode (anode) connected to the slot and an anode (cathode) connected to the other diode in the pair of diodes. More generally, some approaches use a pair of oppositely-oriented two-port elements, e.g. where each element defines a port A and a port B, with the ports A being connected to the slot and the ports B being commonly connected to a bias line. The oppositely-oriented two-port elements can be identical oppositely-oriented two-port elements.

In some approaches, the pair of two-port elements 451, 452 is a pair of two-port elements configured so that a second harmonic generated by one element is substantially cancelled by a second harmonic generated by the other element. For example, the pair of two-port elements might be a pair of identical, oppositely-oriented elements having equal and opposite second harmonic responses. The cancellation need not be exact; for example, the second harmonic response of one element may cancel about 50%, 75%, 80%, 90%, 95%, 98%, or 99% of the second harmonic response of the other element.

In some approaches that provide multiple stations per unit cell, the loading at an upper station 430 and the loading at a lower station 440 may be selected to provide a broader frequency response of the unit cell. In one approach, the loading at the upper station 430 may be designed to provide a desired loading for a first frequency channel of the antenna, while the loading at the lower station 440 may be designed to provide a desired loading for a second frequency channel of the antenna. In another approach, the broader frequency response is achieved by positioning the first and second stations to reduce or minimize a frequency variation of the unit cell's frequency response (e.g. as characterized by a scattering parameter for the unit cell). Alternatively or additionally, the broader frequency response is achieved by selecting the loadings at the first and second stations (e.g. selecting the lumped elements at the first and selecting stations, or selecting their configurations and/or biases) to reduce or minimize a frequency variation of the unit cell's frequency response.

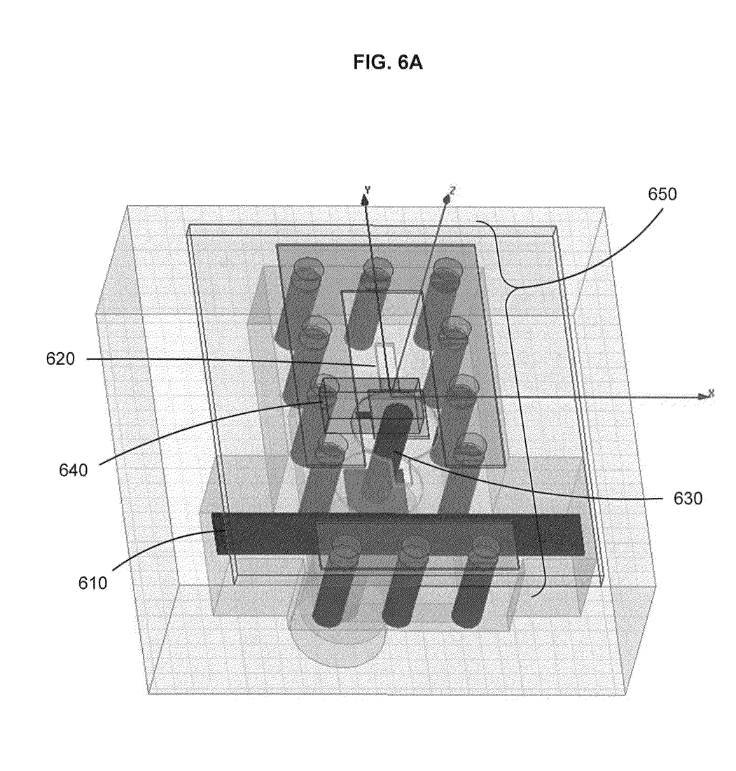

With reference now to FIG. 5, a third illustrative embodiment of a surface scattering antenna is depicted. The figure depicts a unit cell of the antenna, including a first slot 500 coupled to a left edge of the stripline 520 and a second slot 501 coupled to a right edge of the stripline 520. The slots are optionally enclosed in a cavity 510 defined by a via cage 512. While the example depicts the first and second slots at an equal position along the length of the stripline, in other approaches the first and second slots are at staggered positions along the length of the stripline; for example, the second slots may be positioned at midpoints between the positions of the first slots of adjacent unit cells.

With reference now to FIGS. 6A and 6B, a fourth illustrative embodiment of a surface scattering antenna is depicted. FIG. 6A depicts a unit cell of the embodiment, while FIG. 6B depicts the metal layers 601-606 of a multi-layer PCB process implementing the embodiment (the intervening dielectric layers are not shown). In this embodiment, the stripline 610 is implemented on layer 603 with an upper ground plane 602 and a lower ground plane 604. The unit cell scattering element is implemented as a slot 620 in the upper ground plane 602 having a “keyhole” shape whereby to admit a bias line 630 for the lumped element 640 that provides the adjustability for the scattering element. Thus, the “keyhole” opening includes an antipad enclosing a pad 621 for the bias line. In one approach, the lumped element 640 is connected directly to the metal layer 602 to extend between the continuous ground plane and the bias pad 621; in another approach, the antenna includes an optional top metal layer 601 and the lumped element 640 is connected between an upper bias pad 661 and a metal region 662 (the metal portions 661 and 662 being connected by vias to the bias pad 621 and upper ground plane 602, respectively). The keyhole slot 620 is backed by a cavity defined by the upper ground plane 602, the lower ground plane 604, and a via cage 650 that extends at least from metal layer 602 to metal layer 604 (the vias may extend further as appropriate to simplify the PCB manufacturing process). A lower metal layer 605 includes RF stub chokes 660 for the bias lines, which continue to extend to a bottom layer 606 for control circuitry. Thus, the bias lines 630 extend from the topmost metal layer 601 or 602 to the bottommost metal layer 606, with the RF stub chokes and antipads providing electrical isolation through the metal layers shown in FIG. 6B.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

One skilled in the art will recognize that the herein described components (e.g., steps), devices, and objects and the discussion accompanying them are used as examples for the sake of conceptual clarity and that various configuration modifications are within the skill of those in the art. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, those skilled in the art will appreciate that recited operations therein may generally be performed in any order. Examples of such alternate orderings may include overlapping, interleaved, interrupted, reordered, incremental, preparatory, supplemental, simultaneous, reverse, or other variant orderings, unless context dictates otherwise. With respect to context, even terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An antenna, comprising:
a waveguide;
a plurality of subwavelength radiative elements coupled to the waveguide; and
a plurality of lumped element circuits coupled to the subwavelength radiative elements and configured to adjust radiation characteristics of the subwavelength radiative elements.

2. The antenna of claim 1, wherein the waveguide is a stripline waveguide.

3. The antenna of claim 1, wherein the waveguide includes a bounding surface, and the plurality of subwavelength radiative elements includes a plurality of unit cells each containing a slot in the bounding surface.

4. The antenna of claim 3, wherein the waveguide defines a propagation direction, and the subwavelength radiative elements have inter-element spacings along the propagation direction that are substantially less than a free-space wavelength corresponding to an operating frequency band of the antenna.

5. The antenna of claim 4, wherein the inter-elements spacings are less than or equal to one-third of the free-space wavelength.

6. The antenna of claim 4, wherein the inter-elements spacings are less than or equal to one-fourth of the free-space wavelength.

7. The antenna of claim 4, wherein the inter-elements spacings are less than or equal to one-fifth of the free-space wavelength.

8. The antenna of claim 4, wherein each slot defines a slot width dimension and a slot length dimension, and the slot length dimension is substantially equal to one-half of the free-space wavelength.

9. The antenna of claim 8, wherein the slot length dimension corresponds to a direction perpendicular to the propagation direction.

10. The antenna of claim 3, wherein the lumped circuit elements include, for each of the plurality of unit cells, a three-port element with a first port connected to one side of the slot and a second port connected to another slide of the slot.

11. The antenna of claim 10, further comprising, for each of the plurality of unit cells:
a bias voltage line connected to a third port of the three-port element.

12. The antenna of claim 10, wherein each three-port element is a transistor.

13. The antenna of claim 3, wherein the lumped circuit elements include, for each of the plurality of unit cells, a pair of two-port elements connected in series across the slot.

14. The antenna of claim 13, wherein the pair of two-port elements is a diode and a blocking capacitor.

15. The antenna of claim 13, further comprising, for each of the plurality of unit cells:
a bias voltage line connected between a node common to the pair of two-port elements.

16. The antenna of claim 13, wherein each pair of two-port elements is a pair of nonlinear variable-impedance devices.

17. The antenna of claim 16, wherein each pair of nonlinear variable-impedance devices is a matched pair of nonlinear variable-impedance devices.

18. The antenna of claim 16, wherein the nonlinear variable-impedance devices include MEMS switched capacitors or MEMS varactors.

19. The antenna of claim 13, wherein the pair of two-port elements is a pair of diodes.

20. The antenna of claim 19, wherein each diode in the pair of diodes has a cathode connected to the slot and an anode connected to the other diode in the pair of diodes.

21. The antenna of claim 19, wherein each diode in the pair of diodes has an anode connected to the slot and a cathode connected to the other diode in the pair of diodes.

22. The antenna of claim 19, wherein the pair of diodes is a pair of varactors.

23. The antenna of claim 13, wherein the pair of two-port elements is a pair of oppositely-oriented two-port elements.

24. The antenna of claim 23, wherein the pair of oppositely-oriented two-port elements is a pair of identical, oppositely-oriented two-port elements.

25. The antenna of claim 13, wherein the pair of two-port elements is configured so that a first 2nd harmonic generated by a first element in the pair of two-port elements is substantially cancelled by a second 2nd harmonic generated by a second element in the pair of two-port elements.

26. The antenna of claim 3, wherein the lumped circuit elements include, for each of the plurality of unit cells, a first lumped element connected at or near an upper end of the slot and a second lumped element connected at or near a lower end of the slot.

27. The antenna of claim 26, wherein the lumped circuit elements further include one or more additional lumped elements connected at one or more additional positions along the slot between the first lumped element and the second lumped element.

28. The antenna of claim 26, wherein:
the radiation characteristics of the subwavelength radiative elements include, for each unit cell, a scattering parameter having a frequency variation at an operating frequency band of the antenna; and
positions of the first and second lumped elements are selected to reduce or minimize the frequency variation of the scattering parameter.

29. The antenna of claim 26, wherein:
the radiation characteristics of the subwavelength radiative elements include, for each unit cell, a scattering parameter having a frequency variation at an operating frequency band of the antenna; and
the first and second lumped elements have respective first and second impedances that vary with frequency, the first and second variable impedances being selected to reduce or minimize the frequency variation of the scattering parameter.

30. The antenna of claim 26, wherein:
the radiation characteristics of the subwavelength radiative elements include, for each unit cell, a total scattering parameter that includes contributions from a first scattering parameter corresponding to the first lumped element and a second scattering parameter corresponding to the second lumped element;
wherein a frequency variation of the first scattering parameter is substantially complementary to a frequency variation of the second scattering parameter.

31. The antenna of claim 26, wherein the first lumped element is a first varactor and the second lumped element is a second varactor.

32. The antenna of claim 26, wherein the first lumped element is a first transistor and the second lumped element is a second transistor.

33. The antenna of claim 26, wherein the first lumped element is a varactor and the second lumped element is a transistor.

34. The antenna of claim 2, wherein the plurality of subwavelength radiative elements includes:
a first plurality of subwavelength radiative elements coupled to a left edge of the stripline waveguide; and
a second plurality of subwavelength radiative elements coupled to a right edge of the stripline waveguide.

35. The antenna of claim 34, wherein the first plurality and the second plurality are positioned at equal positions along a length of the stripline waveguide.

36. The antenna of claim 34, wherein the first plurality and the second plurality are positioned at first and second staggered positions along a length of the stripline waveguide.

37. The antenna of claim 36, wherein the second staggered positions are midpoints between adjacent first positions.

38. The antenna of claim 3, wherein the waveguide is a stripline waveguide, the bounding surface is an upper ground plane of the stripline, and each slot includes an opening sufficient to admit a bias line for the lumped element circuit of that unit cell.

39. The antenna of claim 38, wherein each slot includes narrow first portion that extends from the opening and towards the stripline and a narrow second portion that extends from the opening and away from the stripline.

40. The antenna of claim 39, wherein the opening is a circular antipad enclosing a pad for the bias line.

41. The antenna of claim 38, wherein each slot has a total length equal to about one-half of a free-space wavelength corresponding to an operating frequency band of the antenna, where the total length equals a length of the narrow first portion plus a length of the narrow second portion plus a diameter of the opening.

42. The antenna of claim 38, wherein the stripline waveguide includes a lower ground plane and each bias line extends through both the upper ground plane and the lower ground plane.

43. The antenna of claim 38, further comprising:
a dielectric layer positioned above the upper ground plane, where each bias line extends through the dielectric layer to connect to the lumped element circuit on the upper surface of the dielectric layer.

44. The antenna of claim 42, further comprising:
for each unit cell, a stub choke for the bias line.

45. The antenna of claim 44, wherein each stub choke is configured to provide a high impedance of the bias line at an operating frequency band of the antenna.

46. The antenna of claim 44, wherein each stub choke is positioned on a metal layer positioned below the lower ground plane of the stripline waveguide.

47. The antenna of claim 42, wherein each unit cell includes an arrangement of vias enclosing both the stripline and the slot.

48. The antenna of claim 47, wherein the upper ground plane, the lower ground plane, and the arrangement of vias define a cavity volume for the unit cell.
